(19) United States
(12) Patent Application Publication
(10) Pub. No.: US 2022/0378094 A1
(43) Pub. Date: Dec. 1, 2022

(54) BATTERY ASSEMBLY AND ELECTRONIC VAPORIZATION DEVICE

(71) Applicant: SHENZHEN SMOORE TECHNOLOGY LIMITED, Shenzhen (CN)

(72) Inventors: Zhijia LIANG, Shenzhen (CN); Zhinan MING, Shenzhen (CN); Pifa SHEN, Shenzhen (CN)

(21) Appl. No.: 17/824,089

(22) Filed: May 25, 2022

(30) Foreign Application Priority Data
Jun. 1, 2021 (CN) 202110609740.5

(51) Int. Cl. A24F 40/40; H01M 50/247; H01M 50/262; H01M 50/202; H01M 50/284

(52) U.S. Cl. CPC A24F 40/40; H01M 50/247; H01M 50/262; H01M 50/202; H01M 50/284; H01M 2220/30

(57) ABSTRACT

A battery assembly includes: a circuit board; at least one clamping component disposed on the circuit board; and at least one conductive component inserted into the at least one clamping component so as to be electrically connected to the circuit board through the at least one clamping component. In an embodiment, the battery assembly further includes a bracket having a first accommodating groove, the circuit board being accommodated in the first accommodating groove. The at least one clamping component is located on a side of the circuit board away from a bottom of the first accommodating groove.

### CROSS-REFERENCE TO PRIOR APPLICATION

Priority is claimed to Chinese Patent Application No. CN 202110609740.5, filed on Jun. 1, 2021, the entire disclosure of which is hereby incorporated by reference herein.

### FIELD

The present invention relates to the field of electronic vaporization devices, and in particular, to a battery assembly and an electronic vaporization device.

### BACKGROUND

In existing electronic vaporization devices, generally, a POGOPIN connector is connected to a circuit board via a wire. This method has a disadvantage of space waste and high labor cost.

### SUMMARY

In an embodiment, the present invention provides a battery assembly, comprising: a circuit board; at least one clamping component disposed on the circuit board; and at least one conductive component inserted into the at least one clamping component so as to be electrically connected to the circuit board through the at least one clamping component.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a main view of an embodiment of a battery assembly of the present invention;

FIG. 2 is a side view of an embodiment of the battery assembly of the present invention;

FIG. 3 is a structural schematic diagram of an embodiment of a conductive component and a clamping component according to the present invention;

FIG. 4 is a structural schematic diagram of an embodiment of the clamping component according to the present invention;

FIG. 5 is a schematic diagram of a preparation process of an embodiment of the clamping component according to the present invention; and

FIG. 6 is a structural schematic diagram of an embodiment of an electronic vaporization device according to the present invention.

### DETAILED DESCRIPTION

In an embodiment, the present invention provides a battery assembly and an electronic vaporization device, which are simple to assemble, convenient to produce, and have low cost.

In an embodiment, the present invention provides a battery assembly, including: a circuit board; a clamping component, disposed on the circuit board; and a conductive component, inserted into the clamping component to be electrically connected to the circuit board through the clamping component.

The battery assembly includes a bracket, the bracket including a first accommodating groove, where the circuit board is accommodated in the first accommodating groove, and the clamping component is located on a side of the circuit board away from a bottom of the first accommodating groove.

A side of the clamping component close to the circuit board is provided with a viscous substance, which is configured to electrically connect the clamping component to the circuit board; or the battery assembly includes a bonding component, located between the clamping component and the circuit board, and configured to electrically connect the clamping component to the circuit board.

The bracket further includes a second accommodating groove that accommodates a battery core; the first accommodating groove and the second accommodating groove are spaced apart; and a sidewall of the first accommodating groove away from the second accommodating groove is provided with a through hole corresponding to a position of the clamping component, the conductive component being inserted into the clamping component through the through hole.

The number of the clamping components is two, the number of the conductive components is two, and one conductive component is inserted into one clamping component.

The clamping component includes: a main body, provided with an accommodating cavity having an insertion port for insertion of the conductive component; a first clamping piece and a second clamping piece, located inside the accommodating cavity and exposed through the insertion port; a first end of the first clamping piece and a first end of the second clamping piece are disposed close to the insertion port and respectively connected to opposite two sidewalls of the accommodating cavity; and a second end of the first clamping piece and a second end of the second clamping piece are disposed away from the insertion port and extend toward the interior of the accommodating cavity, so as to form a clamp configured to clamp the conductive component.

The first clamping piece, the second clamping piece, and the main body are integrally formed.

A middle part of the first clamping piece is disposed inclined relative to a sidewall of the accommodating cavity, and a second end of the first clamping piece is bent relative to the middle part of the first clamping piece and is parallel to the sidewall of the accommodating cavity; and a middle part of the second clamping piece is disposed inclined relative to the sidewall of the accommodating cavity, and the second end of the second clamping piece is bent relative to the middle part of the second clamping piece and is parallel to the sidewall of the accommodating cavity.

The main body is a hollow tubular body, and opposite two sidewalls of the first clamping piece and the second clamping piece are of a hollowed-out structure.

In order to resolve the above technical problem, a second technical solution provided by the present invention is to provide an electronic vaporization device, including a vaporizer and a battery assembly, the battery assembly being configured to supply power to the vaporizer and including the battery assembly according to any one of the above.

Regarding the beneficial effect of the present invention, different from the related art, in the battery assembly and the electronic vaporization device provided by the present invention, the clamping component is disposed on the circuit board, and the conductive component is inserted into the clamping component to be electrically connected to the circuit board through the clamping component, which is simple to assemble, convenient to produce, and has low cost.

The technical solutions in the embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

The terms “first”, “second”, and “third” in this application are used for descriptive purposes only and are not to be construed as indicating or implying relative importance or implicitly indicating the number of technical features indicated. Therefore, features defining “first”, “second”, and “third” can explicitly or implicitly include at least one of the features. In description of this application, “more” means at least two, such as two and three unless it is specifically defined otherwise. All directional indications (for example, up, down, left, right, front, back) in the embodiments of this application are only used for explaining relative position relationships, movement situations or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units, but further optionally includes a step or unit that is not listed, or further optionally includes another step or unit that is intrinsic to the process, method, product, or device.

Embodiment mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

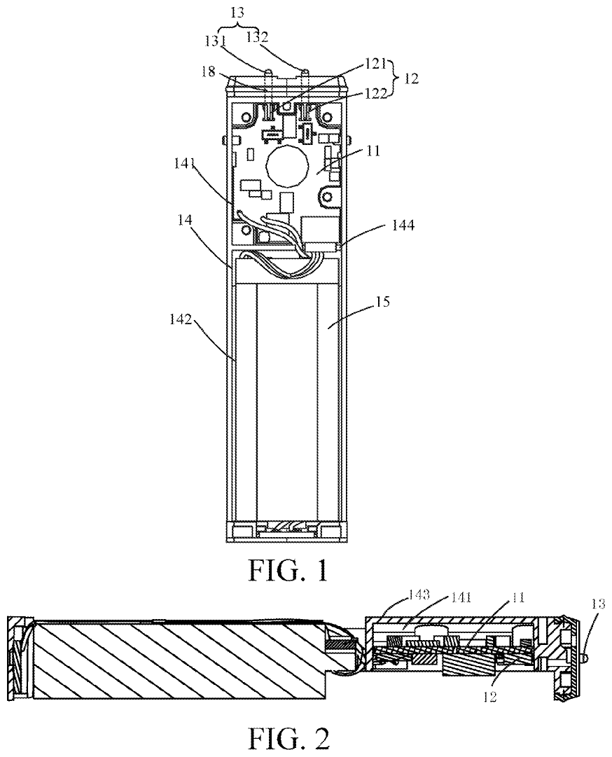

Referring to FIG. 1 and FIG. 2, FIG. 1 and FIG. 2 are structural schematic diagrams of an embodiment of a battery assembly according to the present invention. Specifically, the battery assembly includes a circuit board 11, a clamping component 12, and a conductive component 13. Specifically, the clamping component 12 is disposed on the circuit board, the clamping component 12 is located on one side of the circuit board, and the conductive component 13 is inserted into the clamping component 12 to be electrically connected to the circuit board 11 through the clamping component 12. The conductive component 13 may be a metal needle or other components that can be inserted into the clamping component 12, which is not limited in this application.

Specifically, the battery assembly is also provided with a bracket 14 that includes a first accommodating groove 141 and a second accommodating groove 142. The circuit board 11 is accommodated in the first accommodating groove 141, and the clamping component 12 is located on a side of the circuit board 11 away from a bottom 143 of the first accommodating groove 141, as shown in FIG. 2 in detail. A battery core 15 is located in the second accommodating groove 142. In a specific embodiment, the first accommodating groove 141 and the second accommodating groove 142 are spaced apart with a common sidewall 144 therebetween. Specifically, a sidewall of the first accommodating groove 141 away from the second accommodating groove 142 has a through hole 18 corresponding to a position of the clamping component 12, and the conductive component 13 is inserted into the clamping component 12 via the through hole 18. That is, the sidewall of the first accommodating groove 141 away from the second accommodating groove 142 forms a connection portion, and the connection portion can alternatively be provided with a connector such as a magnetic suction piece in addition to the conductive component 13.

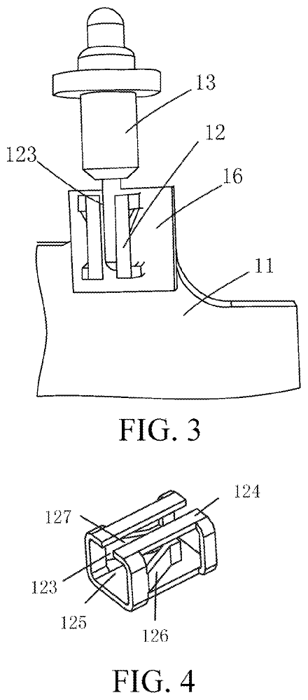

In an embodiment, a side of the clamping component 12 close to the circuit board 11 has a viscous substance. The viscous substance may be a conductive adhesive. The clamping component 12 is bonded to the circuit board 11 for electrical connection with the circuit board 11. In another embodiment, the clamping component 12 can alternatively be electrically connected to the circuit board 11 by other bonding components. Specifically, as shown in FIG. 3, the battery assembly further includes a bonding component 16. The bonding component 16 is located between the clamping component 12 and the circuit board 11, and configured to electrically connect the clamping component 12 to the circuit board 11. In an embodiment, the bonding component 16 is a viscous conductive material, such as conductive glue or the like. The bonding component 16 is located between the circuit board 11 and the clamping component 12 to fix the clamping component 12 on the circuit board 11. Further, the material of the clamping component 12 is a conductive material, for example, a metal such as copper or silver, or an alloy. After the conductive component 13 is inserted into the clamping component 12, the conductive component 13 is electrically connected to the circuit board 11 by the clamping component 12 and the bonding component 16.

In an embodiment, the bonding component 16 can alternatively be located around the clamping component 12 to bond the clamping component 12 onto the circuit board 11. Alternatively, in another embodiment, a concave groove configured to accommodate the clamping component 12 can alternatively be disposed on the circuit board 11. The clamping component 12 is fixed in the concave groove, thereby being electrically connected to the circuit board 11, or the clamping component 12 is fixed in the concave groove through the bonding component 16, such as a conductive adhesive, thereby being electrically connected to the circuit board 11.

In a specific embodiment, the conductive component 13 is a Pogo pin connector. The pogo pin is a spring pin formed by riveting and prepressing three basic components: a pin shaft, a spring, and a pin tube, through a precision instrument, and there is a precision spring structure in the pogo pin. The surface plating of the pogo pin is generally gold plated, which can better improve the corrosion resistance, mechanical properties, electrical properties, and the like. The needle tip may be a pointed needle, a gripping needle, a round needle, a knife-shaped needle, or the like. Pogo pins are commonly applied for precision connection in electronic products in the field of cell phones, communication, automobiles, medical treatment, aerospace, and the like, which can improve the corrosion resistance, stability, and durability of these connectors. Because the pogo pin is a very fine pin, the application of the pogo pin in precision connectors can reduce the weight of the connector as well as the volume of the appearance, which enables the connector to be more refined and aesthetic.

In an embodiment, the number of the clamping components 12 is two, the number of the conductive components 13 is two, and one conductive component 13 is inserted into one clamping component 12. Specifically, as shown in FIG. 1, the clamping component 12 includes a first clamping component 121 and a second clamping component 122, and the conductive component 13 includes a first conductive component 131 and a second conductive component 132. The first conductive component 131 is inserted into the first clamping component 121, and the first conductive component 131 is electrically connected to the circuit board 11 through the first clamping component 121 and the corresponding bonding component 16. The second conductive component 132 is inserted into the second clamping component 122, and the second conductive component 132 is electrically connected to the circuit board 11 through the second clamping component 122 and the corresponding bonding component 16.

Specifically, as shown in FIG. 4, the clamping component 12 includes a main body 124, a first clamping piece 126, and a second clamping piece 127. The main body 124 is provided with an accommodating cavity 125, and the accommodating cavity 125 has an insertion port 123 for insertion of the conductive component 13. The first clamping piece 126 and the second clamping piece 127 are located inside the accommodating cavity 125, and are exposed through the insertion port 123. a first end of the first clamping piece 126 and a first end of the second clamping piece 127 are disposed close to the insertion port 123 and respectively connected to opposite two sidewalls of the accommodating cavity 125; and a second end of the first clamping piece 126 and a second end of the second clamping piece 127 are disposed away from the insertion port 123 and extend toward the interior of the accommodating cavity 125, so as to form a clamp configured to clamp the conductive component 13.

Specifically, a middle part of the first clamping piece 126 is disposed inclined relative to a sidewall of the accommodating cavity 125, and a second end of the first clamping piece 126 is bent relative to the middle part of the first clamping piece 126 and is parallel to the sidewall of the accommodating cavity 125; and a middle part of the second clamping piece 127 is disposed inclined relative to the sidewall of the accommodating cavity 125, and the second end of the second clamping piece 127 is bent relative to the middle part of the second clamping piece 127 and is parallel to the sidewall of the accommodating cavity 125.

Specifically, at a position of the clamp formed by the second end of the first clamping piece 126 and the second end of the second clamping piece 127, a distance between the second end of the first clamping piece 126 and the second end of the second clamping piece 127 is less than or equal to an outer diameter of the conductive component 13, so that the clamp is able to clamp the conductive component 13 when the conductive component 13 is inserted into the clamping component 12.

In another embodiment, a spring can alternatively be disposed between the second end of the first clamping piece 126 and the sidewall of the accommodating cavity 125, and between the second end of the second clamping piece 127 and the sidewall of the accommodating cavity 125. When the conductive component 13 is inserted into the clamping component 12, the second end of the first clamping piece 126 and the second end of the second clamping piece 127 are squeezed to move toward the sidewall of the accommodating cavity 125 to compress the spring, and the compressed spring reversely squeezes the second end of the first clamping piece 126 and the second end of the second clamping piece 127, thereby clamping the conductive component 13 and preventing the conductive component 13 from falling off.

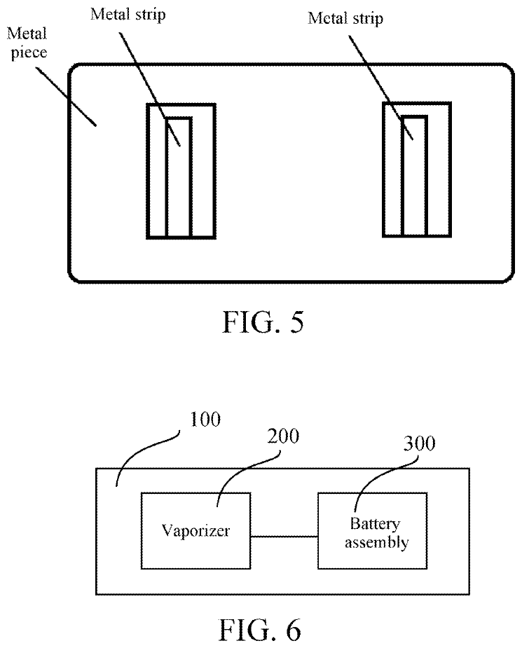

In an embodiment, the first clamping piece 126, the second clamping piece 127, and the main body 124 are integrally formed, and the main body 124 is a hollow tubular body. In another embodiment, in order to reduce the weight of the clamping component 12, opposite two sidewalls of the first clamping piece 126 and the second clamping piece 127 of the clamping component 12 can be constructed as a hollowed-out structure, so that the bonding component 16 can better bond the clamping component 12 onto the circuit board 11. Further, another sidewall to which the opposite two sidewalls of the first clamping piece 126 and the second clamping piece 127 are connected has a notch or a slit, and the notch or the slit extends along an axial direction of the hollow tubular body, so that the sidewall of the hollow tubular body is shaped to be non-closed annular, which also facilitates the preparation of the clamping component 12. Specifically, referring to FIG. 5, the clamping component 12 can be made of a rectangular piece of conductive metal. For example, a rectangular piece of conductive metal is cut to form two metal strips configured to form the first clamping piece 126 and the second clamping piece 127, the rectangular piece of conductive metal is bent to form a shape as shown in FIG. 4, and then the two metal strips are respectively bent toward the interior of the accommodating cavity 125, thereby forming the first clamping piece 126 and the second clamping piece 127.

Through the battery assembly of the present invention, it is not necessary to connect the conductive component 13 to the circuit board 11 via a wire, but rather to connect the conductive component 13 to the circuit board 11 via the clamping component 12, so that the cost can be reduced and it is simple to assemble and convenient to produce.

Referring to FIG. 6, FIG. 6 is a structural schematic diagram of an embodiment of an electronic vaporization device according to the present invention. Specifically, the electronic vaporization device 100 includes a vaporizer 200 and a battery assembly 300. The battery assembly 300 is configured to supply power to the vaporizer 200, and the battery assembly 300 includes the battery assembly 300 shown in any of the foregoing embodiments in FIG. 1 to FIG. 3.

In the electronic vaporization device 100 of the present invention, it is not necessary to connect the conductive component 13 to the circuit board 11 via a wire, but rather to connect the conductive component 13 to the circuit board 11 via the clamping component 12, so that the cost can be reduced and it is simple to assemble and convenient to produce.

The foregoing descriptions are merely implementations of the present invention, and the protection scope of the present invention is not limited thereto. All equivalent structure or process changes made according to the content of this specification and accompanying drawings in the present invention or by directly or indirectly applying the present invention in other related technical fields shall fall within the protection scope of the present invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A battery assembly, comprising:
a circuit board;
at least one clamping component disposed on the circuit board; and
at least one conductive component inserted into the at least one clamping component so as to be electrically connected to the circuit board through the at least one clamping component.

2. The battery assembly of claim 1, further comprising:
a bracket comprising a first accommodating groove, the circuit board being accommodated in the first accommodating groove,
wherein the at least one clamping component is located on a side of the circuit board away from a bottom of the first accommodating groove.

3. The battery assembly of claim 2, wherein a side of the at least one clamping component close to the circuit board is provided with a viscous substance configured to electrically connect the at least one clamping component to the circuit board, or
wherein the battery assembly further comprises: a bonding component located between the at least one clamping component and the circuit board, the bonding component being configured to electrically connect the at least one clamping component to the circuit board.

4. The battery assembly of claim 2, wherein the bracket further comprises a second accommodating groove configured to accommodate a battery core,
wherein the first accommodating groove and the second accommodating groove are spaced apart, and
wherein a sidewall of the first accommodating groove away from the second accommodating groove comprises a through hole corresponding to a position of the at least one clamping component, the conductive component being inserted into the at least one clamping component through the through hole.

5. The battery assembly of claim 1, wherein the at least one clamping component comprises two clamping components, the at least one conductive component comprises two conductive components, and one conductive component of the two conductive components is inserted into one clamping component of the two clamping components.

6. The battery assembly of claim 1, wherein the at least one clamping component comprises:
a main body comprising an accommodating cavity comprising an insertion port for insertion of the at least one conductive component; and
a first clamping piece and a second clamping piece, located inside the accommodating cavity and exposed through the insertion port,
wherein a first end of the first clamping piece and a first end of the second clamping piece are disposed close to the insertion port and respectively connected to opposite two sidewalls of the accommodating cavity, and
wherein a second end of the first clamping piece and a second end of the second clamping piece are disposed away from the insertion port and extend toward an interior of the accommodating cavity so as to form a clamp configured to clamp the at least one conductive component.

7. The battery assembly of claim 6, wherein the first clamping piece, the second clamping piece, and the main body are integrally formed.

8. The battery assembly of claim 7, wherein a middle part of the first clamping piece is disposed inclined relative to a sidewall of the accommodating cavity,
wherein a second end of the first clamping piece is bent relative to the middle part of the first clamping piece and is parallel to the sidewall of the accommodating cavity,
wherein a middle part of the second clamping piece is disposed inclined relative to the sidewall of the accommodating cavity, and
wherein the second end of the second clamping piece is bent relative to the middle part of the second clamping piece and is parallel to the sidewall of the accommodating cavity.

9. The battery assembly of claim 8, wherein the main body comprises a hollow tubular body, and
wherein two opposite sidewalls of the first clamping piece and the second clamping piece each comprises a hollowed-out structure.

10. An electronic vaporization device, comprising:
a vaporizer; and
the battery assembly of claim 1, the batter assembly being configured to supply power to the vaporizer.
